(19) United States
(12) Patent Application Publication
(10) Pub. No.: US 2006/0186847 A1
(43) Pub. Date: Aug. 24, 2006

(54) Control arrangement for a control element for opening and closing a vehicle panel

(75) Inventors: Peter Langer, Karlsruhe (DE); Gerd Reime, Buehl (DE); Frank Rottmann, Dortmund (DE); Juergen Setzer, Illingen (DE); Elmar Winter, Allmersbach (DE); Werner Winter, Ulm-Jungingen (DE)

Correspondence Address: CROWELL & MORING LLP;INTELLECTUAL PROPERTY GROUP, P.O. BOX 14300, WASHINGTON, DC, 20044-4300, US

(73) Assignees: DAIMLERCHRYSLER AG, Stuttgart, DE (US); MECHALESS SYSTEMS GmbH, Karlsruhe (DE)

(21) Appl. No.: 11/345,344

(22) Filed: Feb. 2, 2006

(30) Foreign Application Priority Data
Feb. 3, 2005 (DE) 102005005185.5

(51) Int. Cl. H02P 7/00; E05F 15/10

(52) U.S. Cl. 318/446; 49/26

(57) ABSTRACT

A control arrangement for a control element for opening and closing a hatch in a motor vehicle has a motorized vehicle panel. The control element is designed in such a way that, upon a short actuation of the control element, depending on the direction of actuation of the control element, a control unit outputs a signal to a motor in order to displace the vehicle panel, and the vehicle panel is displaced in response to the signal. A safety operating device for the arrangement has at least one light transmission section which is actuated upon actuation of the control element and which correspondingly outputs an activation confirmation signal to a control unit. The control unit will not output a signal in response to which the motor displaces the vehicle panel until the signal from the control element and the activation confirmation signal from the safety operating device are present at the same time.

This application claims the benefit of the filing date of prior German application 10 2005 005185.5, filed Feb. 3, 2005, the entire disclosure of which is incorporated herein by reference.

### BACKGROUND AND SUMMARY OF THE INVENTION

This invention relates to a control arrangement for a control element which serves for opening and closing a hatch in a motor vehicle having a motorized vehicle panel.

Control elements having control arrangements for operating motorized vehicle panels such as side windows or a sliding roof are known from the prior art.

Appropriate control elements are described in operating instructions for the Mercedes C-class (order number 6515 0131 00, parts number 203 584 4687, edition DE F3 09/03), pages 202-207. In the event of a prolonged actuation of the control element, the sliding roof or the side window is displaced in the direction selected with the aid of the control element until the control element is released or complete opening or complete closure of the roof or of the window is achieved. In accordance with this control arrangement, a one-off brief actuation of the control element causes the roof or window to open completely or close completely if the control element has not previously been actuated. It is immaterial which direction is selected with the aid of the control element in order to stop the movement.

This one-off brief actuation of the control element, also denoted as one touch close, is intended to serve the convenience of the occupant, since he or she can avoid the tiring operation of actuating the control element over the entire duration of opening or closing, if the aim is to achieve complete opening or complete closure. However, precisely because of this convenience, when closing the roof or window by a one-off brief actuation of the control arrangement, it is possible for a brief, unintended actuation of the control element to cause a complete opening or closure which is not intended. This may lead to an unexpectedly moving vehicle panel which in turn could lead to safety risks for the vehicle occupants or people outside the vehicle who are located in the vicinity of the vehicle panel. Furthermore, the existing safety function of stopping upon detection of an arbitrary body which is located in the closing range of the vehicle panel does not exclude a safety risk which might be produced by unintended movement of the vehicle panel.

It is therefore an object of the present invention to develop a control arrangement in which unintended automatic closure or opening is no longer possible.

According to the invention, this object is achieved by a control arrangement including a control element for opening and closing a hatch in a motor vehicle which has a motorized vehicle panel, and a safety operating device. The control element is designed in such a way that, upon a short actuation of the control element, depending on the direction of actuation of the control element, a control unit outputs a signal to a motor in order to displace the vehicle panel, and the vehicle panel is displaced in response to the signal. The safety operating device for the arrangement has at least one light transmission section which is actuated upon actuation of the control element and which correspondingly outputs an activation confirmation signal to a control unit. The control unit will not output a signal in response to which the motor displaces the vehicle panel until the signal from the control element and the activation confirmation signal from the safety operating device are present at the same time.

Automatic closure or opening on the basis of an undesired actuation of the control arrangement is excluded by virtue of the fact that an automatic closure or opening function is activated by the control arrangement only when an additional safety operating device is actuated. This decidedly raises the safety of vehicle occupants and also of people located outside the vehicle in the range of influence of the closable hatches.

Further objects, features, and advantages of the present invention are apparent from the following description of a preferred exemplary embodiment of the invention in conjunction with the drawing figures.

### BRIEF DESCRIPTION OF THE DRAWINGS

FIG. 1 shows the design of a control arrangement according to the invention, and

FIGS. 2 to 10 show various sliding, tilting and compressive actuations of the control element of a control arrangement in accordance with FIG. 1.

### DETAILED DESCRIPTION OF THE INVENTION

A preferred exemplary embodiment of a control arrangement according to the invention for a control element for opening and closing a hatch in a motor vehicle having a motorized vehicle panel is described below in more detail with reference to an example of a sliding roof operating unit.

The control element according to the invention can be implemented by means of known control elements such as, for example, rocker, toggle or slide switches customarily used to operate vehicle panels.

For example, toggle switches are to be found fitted on the transmission tunnel in the vicinity of the handbrake in order to operate the sliding roof in the roofliner, or on the inside of the doors in order to operate the side windows. In order to operate the toggle switch, the operating lever, which is fashioned with a broad area and can be gripped from behind, is pushed or pulled in accordance with the directions of movement of the vehicle panel which are to be actuated.

In the case of rocker switches, the mutually opposed directions of movement of the vehicle panel are assigned to the two halves of the rocker. In order to actuate the side-window panes, rocker switches are fitted, for example, on the inside of the doors, or on the central console between the front seats.

To actuate the sliding roof, the toggle function of a toggle switch is frequently also used to deploy and retract the roof. In order to displace the roof for opening and closing purposes, this switch is then additionally equipped with a possibility of sliding “forwards” and “backwards”, the direction in which the switch is displaced corresponding to the direction in which the roof is displaced. This switch is denoted below as a sliding-lifting roof switch.

Signals are transmitted to a control unit, which is connected communicatively to the control element, by operative actions at the control element. The control unit evaluates these signals and generates therefrom control signals for the corresponding vehicle panel to which the control unit is likewise connected communicatively.

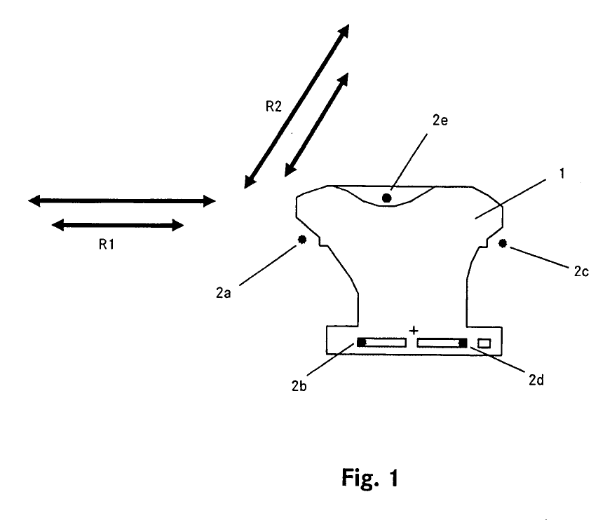

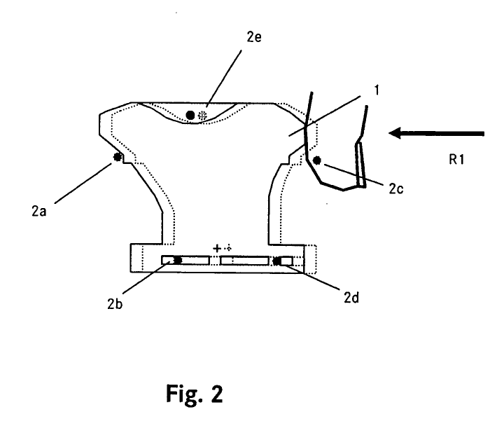

An example of an inventive control arrangement is shown in FIG. 1. FIGS. 2 to 10 illustrate various sliding, tilting or compressive movements upon actuation of the control arrangement.

Denoted by 1 in FIGS. 1 to 10 is a control element, specifically a known sliding-lifting roof switch constructed as mentioned above, which can be actuated to execute sliding, tilting and/or compressive movements. 2a, 2c, 2d and 2e denote first to fifth light transmission sections of a safety operating device. The first, third and fifth light transmission sections 2a, 2c and 2e can also be used together with the second and fourth light transmission sections 2b and 2d in order to change over the actual switch function.

The first to fifth light transmission sections 2a to 2e are respectively shown in cross section in FIGS. 1 to 10, and each have a transmitter (not shown), a receiver (not shown) and a light transmission path constructed therebetween and shown in section. The transmitters and receivers are connected to a control unit (not shown) which, in turn, is connected for driving purposes to a motor for displacing a vehicle panel. Alternatively, the first to fifth light transmission sections 2a to 2e can be embodied such that a common receiver is illuminated by all the transmitters via a light-guiding element, or such that a number of receivers are respectively illuminated by one or more transmitters via light-guiding elements. The individual transmitters can then be activated in temporal succession via a control unit (not shown), and/or in specific combinations, such that the control unit can deduce from the output signal of the common receiver or, in the case of a number of receivers, from the output signals of the various receivers, which actuation has occurred, and can drive the motor (not shown) accordingly in order to displace the vehicle panel, here the sliding-lifting roof. Furthermore, it is possible to deduce from the output signal(s) whether corresponding actuation cycles of the light transmission sections are consistent with the actuation cycles prescribed by the geometry of the control element. It is thereby possible to diagnose defects in transmitters, receivers and/or light transmission sections, or to diagnose instances of soiling. By controlling the transmitting powers of light transmission sections with respect to one another, and by appropriately evaluating the control signals, it is possible to diagnose instances of soiling and ageing effects and/or to compensate extraneous light influences.

For the purpose of better comprehension, FIGS. 2 to 10 show a diagrammatic human finger with the aid of which sliding, tilting and/or compressive movements can be executed.

The safety operating device in the form of at least one light transmission section 2a to 2e is designed in such a way that, upon operation of the control element 1, the light transmission path is interrupted so as to reduce the intensity at the receiver in the case of the use of a common or separate receiver(s). The first to fifth light transmission sections 2a to 2e are arranged in this case such that, on the basis of the geometry of the control element 1, they can be actuated only upon an intentional actuation with a finger, but not with the aid of a larger body part, for example a knee.

FIG. 2 shows an actuation of the control element 1 in the form of a sliding movement in a first direction RI as far as a first latch, the control element 1 being illustrated by dots in its initial position as point of reference. In the actuation shown in FIG. 2, a third light transmission section 2c is actuated by the actuating finger, that is to say the associated light transmission path is interrupted. The displacement of the control element 1 then actuates the fourth light transmission section 2d, that is to say the associated light transmission path is interrupted. In this state with the control element actuated in such a way, therefore, two light transmission sections are interrupted: the third light transmission section 2c by the finger (safety function), and the fourth light transmission section 2d by the actuation of the control element 1 itself.

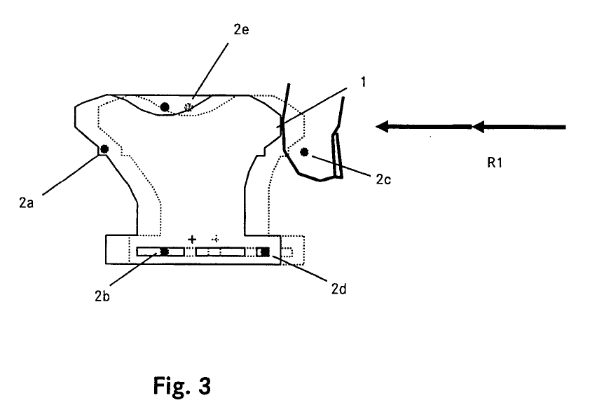

FIG. 3 illustrates a further movement of the control element 1 in the form of a further sliding movement in the first direction R1 as far as a second latch. Here, in addition to the actuation of the third light transmission section 2c by the finger, two further light transmission sections are altered by the sliding movement, specifically the fourth light transmission section 2d, which is released again, and a first light transmission section 2a, which is actuated, that is to say the associated light transmission path of the light transmission section 2a is interrupted.

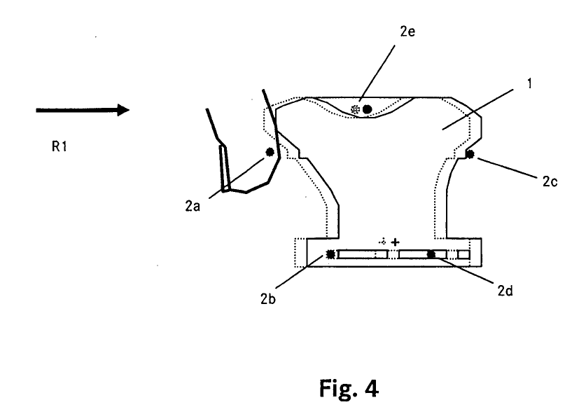

Furthermore, an actuation, corresponding to FIG. 2, in an opposite direction R1 as far as the first latch is depicted in FIG. 4. Here, the first light transmission section 2a is actuated by the finger, and the second light transmission section 2b is actuated (for the actual control function) by the displacement of the control element 1.

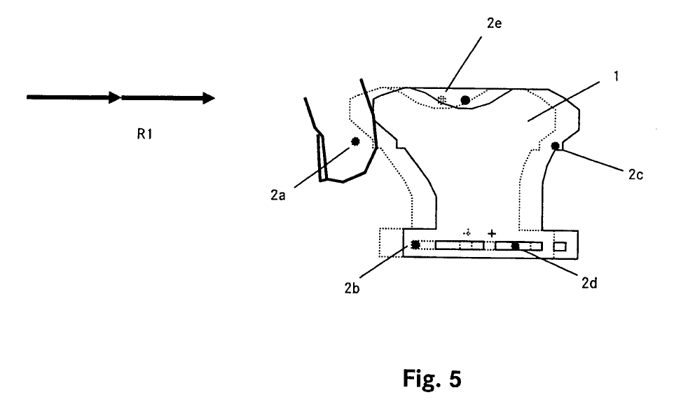

FIG. 5 illustrates further movement of the control element 1 in the direction R1 as far as the second latch. The third light transmission section 2c is actuated in addition by the further movement of the control element 1.

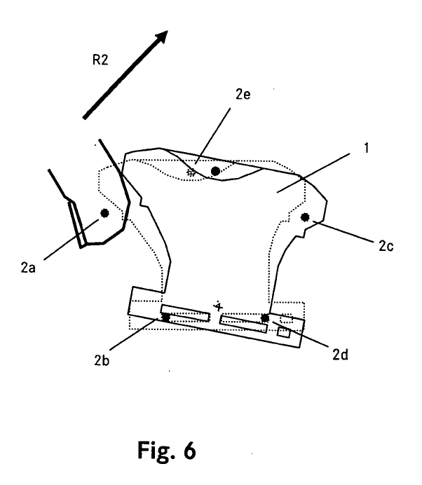

Further to be seen in FIG. 6 is an actuation of the control element 1 by a tilting movement in a second direction R2 from the initial state, shown by dots, of the control element 1. In the case of this tilting movement in the second direction R2, the second, the third and the fourth light transmissions 2b, 2c and 2d are actuated in addition to the first light transmission second 2a actuated by the finger, that is to say the associated transmission paths are interrupted.

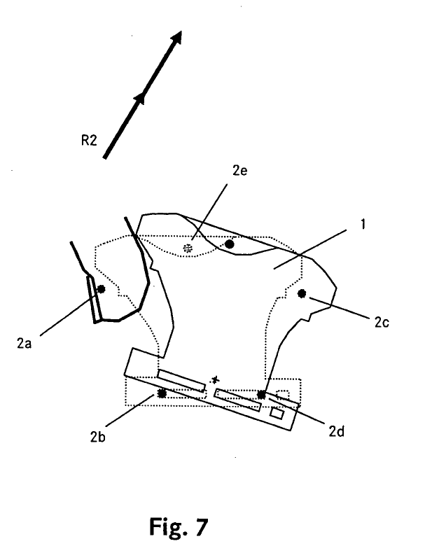

In FIG. 7, the tilting movement from FIG. 6 is continued in the second direction R2 up to the second latch, and the second light transmission section 2e is thereby released again, that is to say the interruption is cancelled.

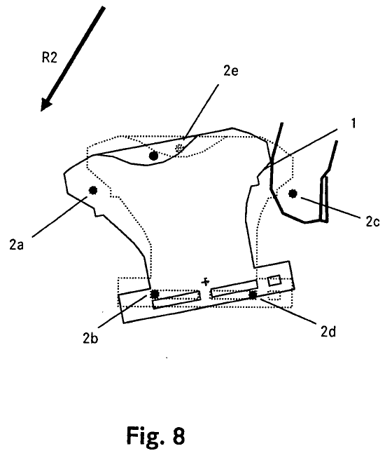

FIG. 8 shows an actuation of the control element 1 by a tilting movement in the direction opposite to the second direction R2, with reference to the initial state of the control element 1 shown by dots. In the case of this tilting movement in the direction opposite to the second direction R2, the first, the second and the fourth light transmission sections 2a, 2b and 2d are activated in addition to the third light transmission section 2c activated by the finger, that is to say the associated transfer paths are interrupted.

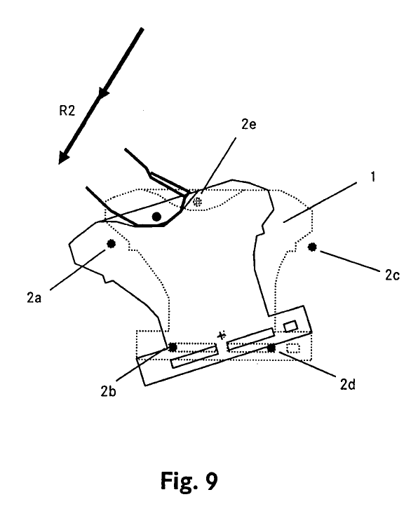

In FIG. 9, the tilting movement from FIG. 8 is continued up to the second latch, and thereby the fourth light transmission section 2d is released again, that is to say the interruption of the associated transmission path is cancelled.

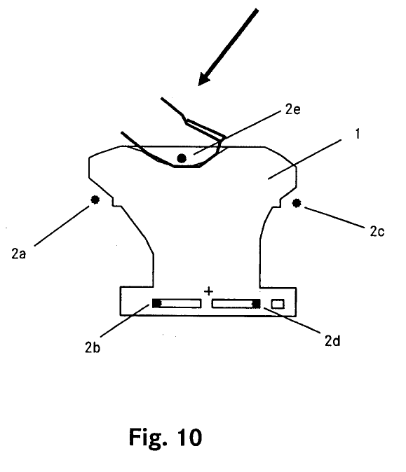

Operating functions which are actuated by pressure on the control element 1 can be secured with the aid of at least one light transmission section 2e, which is situated in at least one trough on the top side of the control element 1. Such a trough is preferably adapted in terms of its geometry to a human finger. This is illustrated in FIG. 10. In this case, when the finger presses on the control element 1, the light transmission section 2e is actuated, that is to say the associated transmission path is interrupted.

As shown in the exemplary embodiment, by appropriate geometrical arrangement of various light transmission sections 2a to 2d or 2e, the safety operating device can be embodied relative to the mechanical control element 1, for example at the front and rear, such that it can serve simultaneously to changeover the actual control function. By adding further light transmission sections, it is possible to design the entire operation and protection by means of light transmission sections such that all that is required for the entire switch is one mechanical control element 1. Depending on the embodiment, it is then possible to deduce whether actuation of the mechanical control element has occurred with the aid of a common receiver for all the transmission sections 2a to 2e, or with the aid of a receiver for each transmission section 2a to 2e by evaluating the output signal of the common receiver, or the output signals of the receivers by taking account of the driving of the receivers which has been performed by the control unit.

Multiple latching positions of a control element in a direction such as shown, for example, in FIGS. 2 to 5 can be covered in succession by arranging a number of light transmission sections in the operating direction.

It is possible to achieve independence from extraneous light by means of design measures or appropriate control of the transmitter/receiver signals.

In addition, the output signal of the safety operating device can be used simultaneously to drive a switch illumination.

Finally, the light transmission section can be embodied with the aid of infrared light, and can therefore be rendered invisible to the user.

Moreover, the at least one light transmission section 2a to 2e can also be constructed on a reflective basis so as to be embodied with transmitter and receiver on opposite sides and the light transmission path therebetween, such that transmitter and receiver are located on the same side, and light emitted by the receiver is guided to the receiver via a reflecting element.

Furthermore, the at least one light transmission section 2a to 2e can be either of fixed construction in the control arrangement or of fixed construction in a housing of the control arrangement.

Of course, it is also possible to use the control arrangement according to the invention only to prevent the automatic closure of the vehicle panel, and to continue to permit automatic opening without restriction.

The control arrangement described can also be used for bipartite sliding roofs comprising a cover and a sun shield part which can both be motorized, since there are sliding roof controls which, as described in German publication DE 42 21 043 C2, are provided with a sensibly combined movement of the two parts.

In addition, the control arrangement described above with reference to a sliding roof unit can likewise be used in an operating unit for a side window or side windows.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A control arrangement comprising:
a control element for opening and closing a hatch in a motor vehicle having a motorized vehicle panel, the control element being designed so that, upon a short actuation of the control element and depending on the direction of actuation of the control element, a control unit outputs a signal to a motor in order to displace the vehicle panel and the vehicle panel is displaced in response to said signal, and
a safety operating device which includes at least one light transmission section which is actuated upon actuation of the control element and which correspondingly thereupon outputs an activation confirmation signal to the control unit,
wherein the control unit does not output the signal to the motor in order to displace the vehicle panel until both a signal from the control element and the activation confirmation signal from the safety operating device are present at the same time.

2. The control arrangement according to claim 1, wherein the at least one light transmission section is arranged so that, based on geometry of the control element, it can be actuated only upon an intentional actuation with a finger.

3. The control arrangement according to claim 1, wherein the at least one light transmission section is formed from a transmitter, a receiver, and a light transmission path arranged therebetween, and wherein actuation of the at least one light transmission section is interruption of the light transmission path.

4. The control arrangement according to claim 3, wherein the at least one light transmission section is constructed such that the transmitter and the receiver are located so that light emitted by the transmitter is guided to the receiver via a reflecting element.

5. The control arrangement according to claim 3, wherein the at least one light transmission section is one of a number of light transmission sections, and wherein a common receiver is illuminated via a light-guiding element.

6. The control arrangement according to claim 3, wherein the at least one light transmission section is one of a number of light transmission sections, and wherein a number of receivers are respectively illuminated by at least one transmitter via light-guiding elements.

7. The control arrangement according to claim 4, wherein the transmitter is one of a plurality of individual transmitters activated in at least one of temporal succession and specific combinations, and wherein it is possible to deduce how the control element has been actuated from the output signal of the receiver.

8. The control arrangement according to claim 6, wherein it is possible to deduce from output signals of the various receivers whether corresponding actuation cycles of the light transmission sections are consistent with actuation cycles prescribed by the geometry of the control element, and wherein it is possible therefrom to diagnose soiling or defects in at least one of transmitters, receivers, and light transmission sections.

9. The control arrangement according to claim 7, wherein the transmitting power of the individual transmitters can be interregulated, and wherein instances of soiling and ageing effects can be diagnosed from the received output signals of the receiver, extraneous light influences can be compensated, or instances of soiling and aging effects can be diagnosed and extraneous light influences can be compensated.

10. The control arrangement according to claim 1, wherein the at least one light transmission section is arranged in such a way that the at least one light transmission section is actuated upon a sliding, tilting, or compressive movement of the control element.

11. The control arrangement according to one of claim 1, wherein a number of latching positions of the control element in one direction are in succession covered by arranging a number of light transmission sections.

12. The control arrangement according to claim 1, wherein the safety operating device has a number of light transmission sections which are arranged geometrically in relation to the control element in such a way that they can simultaneously serve to change over the actual control function.

13. The control arrangement according to claim 1, wherein the activation confirmation signal of the safety operating device is used simultaneously to drive a switch illumination.

14. The control arrangement according to claim 1, wherein the at least one light transmission section is embodied with infrared light.

15. The control arrangement according to claim 1, wherein the at least one light transmission section is of fixed construction in the control arrangement.

16. The control arrangement according to claim 1, wherein the at least one light transmission section is of fixed construction in a housing of the control arrangement.

17. The control arrangement according to claim 1, wherein the vehicle panel is a sliding roof.

18. The control arrangement according to claim 1, wherein the vehicle panel is a side window.

19. The control arrangement according to claim 1, wherein the activation confirmation signal is taken into account only when, because of an actuation direction of the control element, there is to be output to the motor in order to displace the vehicle panel a signal in response to which the vehicle panel is displaced until it is completely closed.

20. The control arrangement according to claim 2, wherein the at least one light transmission section is formed from a transmitter, a receiver, and a light transmission path arranged therebetween, and wherein actuation of the at least one light transmission section is interruption of the light transmission path.
